(19) United States
(12) Patent Application Publication
(10) Pub. No.: US 2017/0017338 A1
(43) Pub. Date: Jan. 19, 2017

(54) TOUCH DISPLAY DEVICE

(71) Applicant: InnoLux Corporation, Miao-Li County (TW)

(72) Inventors: Chia-Hao TSAI, Miao-Li County (TW); Jen-Chieh PENG, Miao-Li County (TW); Chih-Hao CHANG, Miao-Li County (TW); Bo-Feng CHEN, Miao-Li County (TW); Tung-Kai LIU, Miao-Li County (TW)

(21) Appl. No.: 15/176,188

(22) Filed: Jun. 8, 2016

Related U.S. Application Data
(60) Provisional application No. 62/193,787, filed on Jul. 17, 2015.

(30) Foreign Application Priority Data
Feb. 4, 2016 (TW) 105103705

(51) Int. Cl. G06F 3/041; G06F 3/044

(52) U.S. Cl. CPC G06F 3/0416; G06F 3/044; G06F 3/0412; G06F 2203/04103; G06F 2203/04102; G06F 2203/04111

(57) ABSTRACT

A touch display device is disclosed, which comprises: a substrate; a thin film transistor unit disposed on the substrate; a first insulating layer disposed on the thin film transistor unit; a touch signal line layer disposed on the first insulating layer; a second insulating layer disposed on the touch signal line layer; a first transparent conducting layer disposed on the second insulating layer; a third insulating layer disposed on the first transparent conducting layer; and a second transparent conducting layer disposed on the third insulating layer.

### CROSS REFERENCE TO RELATED APPLICATION

This application claims the benefits of the Taiwan Patent Application Serial Number 105103705, filed on Feb. 4, 2016, the subject matter of which is incorporated herein by reference.

This application claims the benefit of filing date of U.S. Provisional Application Ser. No. 62/193,787, filed Jul. 17, 2015 under 35 USC §119(e)(1).

### BACKGROUND OF THE INVENTION

1. Field of the Invention

The present invention relates to a touch display device and, more particularly, to a touch display device having touch sensors embedded therein.

2. Description of Related Art

Recently, with the development trend of user-friendly operation and simplicity, touch display devices are becoming more and more widely used in the production and life. Since the user can operate directly by hand or other objects to touch the touch display device, the user's dependence on other input devices (such as a keyboard, a mouse, a remote controller and so on) are thus reduced or even eliminated, thereby greatly facilitating the user's operation.

The touch panel technique may be divided into various types according to three main aspects: signal generating mechanism, sensing technique, and the way of device assembly. According to the signal generating mechanism, it may be divided into digital type and analog type. The digital type touch panel is equipped with a transparent indium tin oxide (ITO) conductive film, on which conductive lines are distributed along the directions of X axis and Y axis and a sensing region is formed at a crossover of the conductive lines. A touch signal is generated when a pressure is applied to the sensing region of the digital type touch panel. On the other hand, analog type is different from digital type by a dot spacer disposed between the upper and lower electrode layers. When a touch is applied to the analog type touch panel, the upper and lower electrode layers are electrically connected to generate a potential difference signal, this potential difference signal is then transferred to a controller by a circuit, and the signal transferred to the controller is processed and calculated to obtain the coordinate position of the touch spot. Furthermore, according to sensing technique, the touch panel technique may be divided into electric signal types (including resistance type, capacity type, electromagnetic type, and so on), light signal types (including infrared type and the like), and sound signal types (including surface acoustic wave type, acoustic waveguide type, chromatic dispersion signal type, sound pulse type, and so on).

However, among all the aforementioned types of the touch panel techniques, the breakages of the touch signal lines may cause the malfunctions of the touch sensing, resulting in the touch quality reduced. Therefore, it is desirable to provide a touch display device, which can reduce the risk of the breakages of the touch signal lines, and further improve the yields of the touch display device.

### SUMMARY OF THE INVENTION

An object of the present disclosure is to provide a touch display device, which can not only prevent the breakage of the touch signal line but also maintain the storage capacitance between the pixel electrode and the common electrode.

The touch display device comprises: a substrate; a thin film transistor unit disposed on the substrate; a first insulating layer disposed on the thin film transistor unit; a touch signal line layer disposed on the first insulating layer; a second insulating layer disposed on the touch signal line layer; a first transparent conducting layer disposed on the second insulating layer; a third insulating layer disposed on the first transparent conducting layer; and a second transparent conducting layer disposed on the third insulating layer.

In one aspect of the present disclosure, the thin film transistor unit may comprise a source/drain layer, the first transparent conducting layer may electrically connects to the source/drain layer through a first contact via, and the first transparent conducting layer is used as a pixel electrode. Meanwhile, the second transparent conducting layer may comprise plural touch electrode patterns, and the touch electrode patterns may electrically connect to the touch signal line layer through a second contact via. The second transparent conducting layer may further comprise a common electrode; thus, a touch display device with a top common electrode and a bottom pixel electrode can be provided.

In another aspect of the present disclosure, the thin film transistor unit may comprise a source/drain layer, the second transparent conducting layer may electrically connect to the source/drain layer through a first contact via, and the second transparent conducting layer is used as a pixel electrode. Meanwhile, the first transparent conducting layer may comprise plural touch electrode patterns, and the touch electrode patterns may electrically connect to the touch signal line layer through a second contact. The first transparent conducting layer may further comprise a common electrode; thus, a touch display device with a top pixel electrode and a bottom common electrode can be provided.

In the touch display device with a top common electrode and a bottom pixel electrode as well as the touch display device with a top pixel electrode and a bottom common electrode provided by the present disclosure, the second insulating layer and the third insulating layer are laminated on the touch signal line layer. Even though tiny particles are adhered on the touch signal lines of the touch signal line layer during the process for preparing the touch display device, the breakage of the touch signal line can be prevented due to the dispositions of the second insulating layer and the third insulating layer on the touch signal line layer. In addition, in the touch display device of the present disclosure, no matter which one of the first transparent conducting layer and the second transparent conducting layer is used as the pixel electrode or the common electrode, only the third insulating layer is disposed between these two transparent conducting layer; therefore, the storage capacitance between these two transparent conducting layer is not decreased since the increased distance between these two transparent conducting layer caused by the dispositions of plural insulating layers therebetween is not occurred, so the storage capacitance and the electricity between these two transparent conducting layer can be maintained.

Other objects, advantages, and novel features of the invention will become more apparent from the following detailed description when taken in conjunction with the accompanying drawings.

### BRIEF DESCRIPTION OF THE DRAWINGS

FIG. 1 is a top view of a touch display device according to the present disclosure;

FIG. 2 is a cross-sectional view of a touch display device according to one preferred embodiment of the present disclosure;

FIG. 3 is a cross-sectional view of a touch display device according to one comparative embodiment of the present disclosure;

FIG. 4 is a cross-sectional view of a touch display device according to another preferred embodiment of the present disclosure;

FIG. 5 is a cross-sectional view of a touch display device according to another comparative embodiment of the present disclosure;

FIG. 6 is a timing diagram showing signals applied to the touch display device of the present disclosure;

FIG. 7 is a wave diagram showing actual signals of touch signal lines and touch electrodes connecting thereto; and

FIG. 8 is a wave diagram showing signals of touch signal lines and touch electrodes connecting thereto when a user touches a specific touch electrode.

### DETAILED DESCRIPTION OF THE PREFERRED EMBODIMENT

The present invention has been described in an illustrative manner, and it is to be understood that the terminology used is intended to be in the nature of description rather than of limitation. Many modifications and variations of the present invention are possible in light of the above teachings. Therefore, it is to he understood that within the scope of the appended claims, the invention may be practiced otherwise than as specifically described.

Furthermore, the ordinal numbers such as “first”, “second” and “third” used in the present specification and the appended claims are used to modify the units in the appended claims. The ordinal numbers themselves do not mean or represent the claimed units having ordinal numbers, and do not represent the order of one claimed unit to another claimed unit or the sequence of the manufacturing process. The ordinal numbers are used only for naming one claimed unit to clearly distinguish the claimed unit from the other claimed unit having the same term.

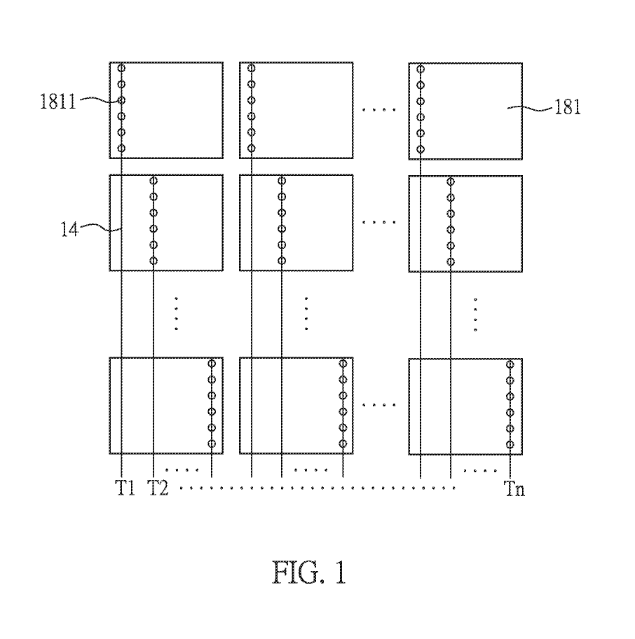

FIG. 1 is a top view of a touch display device according to the present disclosure. The touch display device is an embedded touch display device using the self-capacitance detecting method, which comprises: plural touch electrode patterns 181 and plural touch signal lines 14, wherein each of the touch electrode patterns 118 respectively electrically connects to the touch signal lines 14 through second contact vias 1811. Signals T1, T2 to Tn from the touch signal lines 14 are transmitted to the touch electrode patterns 181 through the second contact vias 1811 for touch operation. A user touches the region of the touch electrode patterns 181 to provide touch signals to the touch electrode patterns 181 and the touch signals are further transmitted back to the touch signal lines 14 through the second contact vias 1811. The user's touch position can be determined, by comparing the signal changes before and after the user touches the touch electrode patterns 181.

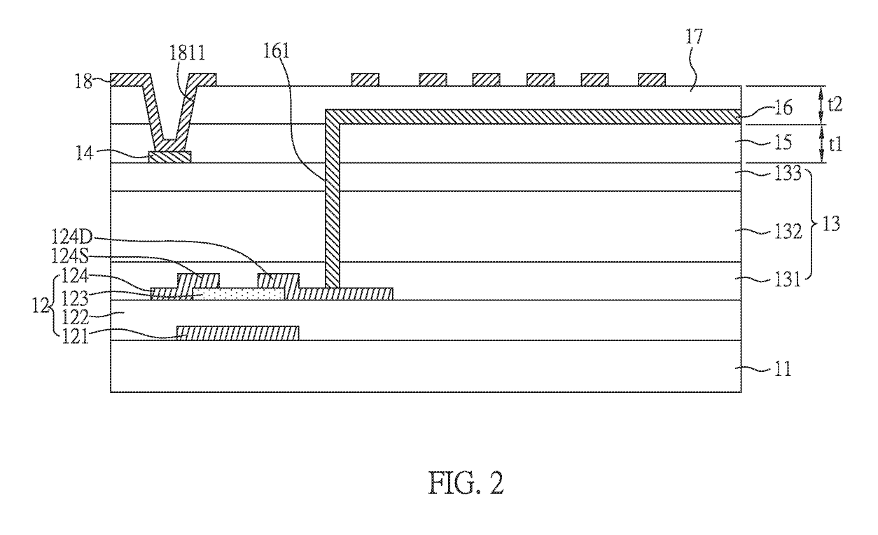

FIG. 2 is a cross-sectional view of a touch display device according to one preferred embodiment of the present disclosure. For illustrating the embodiment succinctly, FIG. 2 shows one pixel structure of the touch display device. As shown in FIG. 2, in the method for preparing the touch display device of the present embodiment, a substrate lit is firstly provided. Next, a gate metal layer 121 is formed on the substrate 11; a gate insulating layer 122 is formed on the substrate 11 and the gate metal layer 121; a patterned semiconductor layer 123 is formed on the gate insulating layer 122, wherein the patterned semiconductor layer 123 corresponds to the gate metal layer 121; and a source/drain layer 124 is formed on the patterned semiconductor layer 123. After these steps, a thin film transistor unit 12 (comprising the gate metal layer 121, the patterned semiconductor layer 123, and the source/drain layer 124) on the substrate 11 is obtained.

Furthermore, the source/drain layer 124 comprises a source electrode 124S and a drain electrode 124D separated from the source electrode 124S. For example, the source electrode 124S connects to a data line.

Next, a first insulating layer 113 is laminated on the thin film transistor unit 12. In the present embodiment, the first insulating layer 13 has a three-layered structure comprising an insulating layer 131, a planer layer 132 and another insulating layer 133 sequentially laminated. However, in other embodiment of the present disclosure, the structure of the first insulating layer 13 is not limited. to the above three-layered structure shown in FIG. 2.

Then, a touch signal line layer comprising a touch signal line 14 is formed on the first insulating layer 13, and a second insulating layer 15 is formed on the first insulating layer 13 and the touch signal line 14. A first transparent conducting layer comprising a pixel electrode 16 is formed on the second insulating layer 15, and the pixel electrode 16 electrically connects to the drain electrode 124D through a first contact via 161, wherein the first contact via 161 is formed by patterning the first insulating layer 13 and the second insulating layer 15. Then, a third insulating layer 17 is formed on the first transparent conducting layer. Next, a second transparent conducting layer 18 is formed on the third insulating layer 17 and is of use to a touch electrode and a common electrode, and the second transparent conducting layer 18 electrically connects to the touch signal line 14 through a second contact via 1811; wherein the second contact via 1811 is formed by patterning the second insulating layer 15 and the third insulating layer 17.

In the present embodiment, the substrate 11 can be formed by any substrate material such as glass, plastic and flexible material. The gate insulating layer 122, the insulating layer 131, the planer layer 132, the insulating layer 133, the second insulating layer 15 and the third insulating layer 17 can be prepared by any insulating material such as oxides, nitrides, nitroxides and organic insulating material. The gate metal layer 121, the source and drain layer 124 and the touch signal line 14 can be prepared by any conductive material, such as metals, alloys, metal oxides, metal nitroxides or other electrode material. The material for the semiconductor layer 123 can be, for example, amorphous silicon, low temperature poly-silicon, IGZO or other material with semiconducting property. The pixel electrode 16 and the second transparent conducting layer 18 can be made of any transparent conductive electrode material such as ITO, IZO or ITZO. However, in other embodiment of the present disclosure, the materials for the aforementioned units are not limited to the above examples.

After the aforementioned steps, a touch display device with a top common electrode and a bottom pixel electrode is obtained, which comprises: a substrate 11; a thin film transistor unit 12 disposed on the substrate 11; a first insulating layer 13 disposed on the thin film transistor unit 12; a touch signal line layer comprising a touch signal line 14 disposed on the first insulating layer 13; a second insulating layer 15 disposed on the touch signal line layer; a first transparent conducting layer comprising a pixel electrode 16 disposed on the second. insulating layer 15; a third insulating layer 17 disposed on the first transparent conducting layer; and a second transparent: conducting layer 18 disposed on the third insulating layer 17. Herein, a thickness t1 of the second insulating layer 15 and a thickness t2 of the third insulating layer 17 can be respectively in a range from 10 nm to 1000 nm.

In the present embodiment, the source/drain layer 124 of the thin film transistor unit 12 electrically connects to the pixel electrode 16 through the first contact via 161. In addition, the second transparent conducting layer 18 electrically connects to the touch signal line 14 through the second contact via 1811. Furthermore, the touch signal line 14 of the touch signal line layer corresponds to the source electrode 124S or the drain electrode 124D of the source/drain layer 124. More specifically, the touch signal line 14 overlaps with the source electrode 124S, the data line or the gate metal layer 121 to prevent the aperture ratio of a pixel decreased.

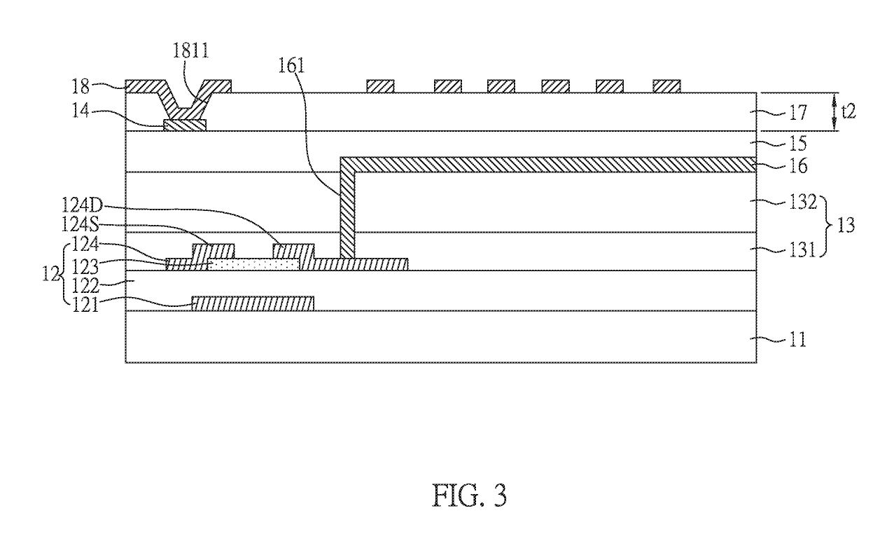

FIG. 3 is a cross-sectional view of a touch display device according to one comparative embodiment of the present disclosure. The structure of the touch display device and the process for preparing the same of the present comparative embodiment is similar to those described above, except for the following differences.

As shown in FIGS. 2 and 3, in the touch display device shown in FIG. 3, the first insulating layer 13 has a double-layered structure, sequentially comprising an insulating layer 131 and a planer layer 132. This two-layered structure can also be applied to the first insulating layer 13 in the touch display device shown in FIG. 2.

In addition, in the touch display device shown in FIG. 3, after forming the first insulating layer 13, a first transparent conducting layer comprising the pixel electrode 16 is firstly formed, and then the second insulating layer 15, the touch signal line layer comprising the touch signal line 14, the third insulating layer 17 and the second transparent conducting layer 18 been of use to a touch electrode and a common electrode are sequentially formed. However, in the touch display device shown in FIG. 2, after forming the first insulating layer 13, the touch signal line layer comprising the touch signal line 14 is firstly formed, and then the second insulating layer 15, the first transparent conducting layer comprising the pixel electrode 16, the third insulating layer 17 and the second transparent conducting layer 18 are sequentially formed.

In the touch display device of shown in FIG. 3, in order to prevent the breakage of the touch signal line 14 due to the tiny particles adhered thereon, the thickness t2 of the third insulating layer 17 has to be increased to protect the touch signal line 14. However, the increased thickness t2 of the third insulating layer 17 may cause the electric field and the storage capacitance between the pixel electrode 16 and the second transparent conducting layer 18 decreased, resulting in the brightness and the flicker level of the display device worse. In order to improve the brightness of the display device, the voltage difference between the pixel electrode 16 and the second transparent conducting layer 18 has to he increased, resulting in the power consumption increased.

However, in the touch display device of the embodiment shown in FIG. 2, the touch signal line 14 is firstly formed, and then the pixel electrode 16 (belonging to the first transparent conducting layer) and the common electrode (belonging to the second transparent conducting layer 18) are formed. Hence, there are two insulating layers including the second insulating layer 15 and the third insulating layer 17 disposed on the touch signal line 14, so the total thickness of the insulating layer over the touch signal line 14 is the thickness t1 plus the thickness t2. Therefore, even though the thickness t2 of the third. insulating layer 17 is not increased, the purpose of protecting the touch signal line 14 and preventing the breakage of the touch signal line 14 can be achieved.

In addition, in the touch display device shown in FIG. 2, only the third insulating layer 17 (having the thickness t2) is disposed between the pixel electrode 16 and the second transparent conducting layer 18. However, in the touch display device shown in FIG. 3, the second insulating layer 15 and the third insulating layer 17 are disposed between the pixel electrode 16 and the second transparent conducting layer 18, which means that the total thickness of the insulating layer between the pixel electrode 16 and the second transparent conducting layer 18 is the thickness a plus the thickness t2. Comparing the touch display devices shown in FIGS. 2 and 3, the total thickness of the insulating layer between the pixel electrode 16 and the second transparent conducting layer 18 in the touch display device shown in FIG. 2 is smaller than that shown in FIG. 3. Hence, the storage capacitance between the pixel electrode 16 and the second transparent conducting layer 18 in the touch display device shown in FIG. 2 is higher than that shown in FIG. 3. Therefore, even though the voltage difference between the pixel electrode 16 and the second transparent conducting layer 18 is not increased, the desired brightness of the touch display device shown in FIG. 2 still can be achieved.

Furthermore, in the touch display device of the embodiment shown in FIG. 2, the second insulating layer 15 and the third insulating layer 17 are disposed between touch signal line 14 and the second transparent conducting layer 18, so the total thickness of the insulating layer between the touch signal line 14 and the second transparent conducting layer 18 is the thickness t1 plus the thickness t2. However, in the touch display device of the comparative embodiment shown in FIG. 3, only the third insulating layer 17 is disposed between the touch signal line 14 and the second transparent conducting layer 18, which has the thickness t1. Comparing the touch display devices shown in FIGS. 2 and 3, the distance between the touch signal line 14 and the second transparent conducting layer 18 in the touch display device shown in FIG. 2 is larger than that in the touch display device shown in FIG. 3. Hence, in other region without the second contact via 1811 formed therein (as shown in FIG. 1), the parasitic capacitance between the touch signal line 14 and the second transparent conducting layer 18 can he reduced. in the touch display device shown in FIG. 2.

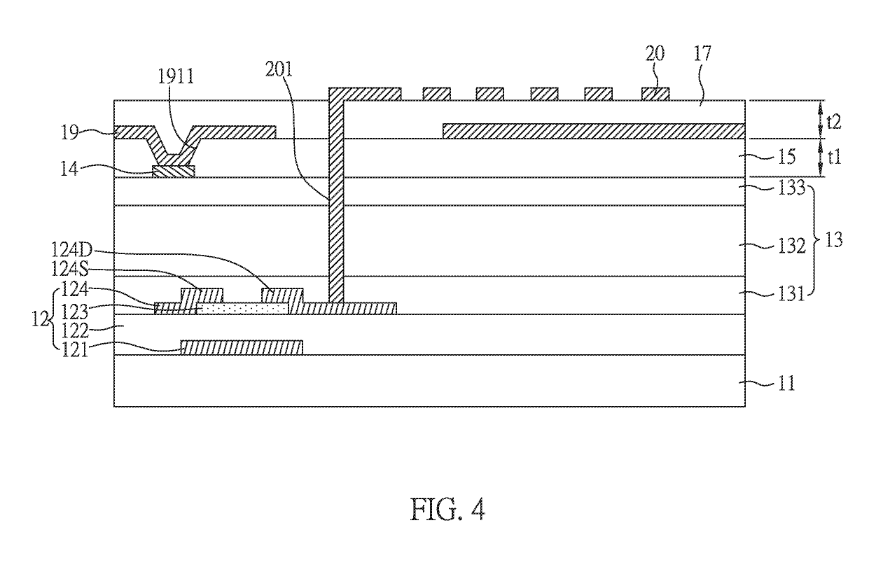

FIG. 4 is a cross-sectional view of a touch display device according to another preferred embodiment of the present disclosure. The structure of the touch display device and the process for preparing the same of the present embodiment are similar to those of the touch display device shown in FIG. 2, except for the following differences.

The touch display device shown in FIG. 2 is a touch display device with a top common electrode and a bottom pixel electrode, wherein the first transparent conducting layer comprises the pixel electrode 16, and the second transparent conducting layer is used as the touch electrode and the common electrode. The touch display device shown in FIG. 4 is a touch display device with a top pixel electrode and a bottom common electrode, wherein a first transparent conducting layer 19 is used of the touch electrode and the common electrode, and the second transparent conducting layer comprises a pixel electrode 20. Hence, in the touch display device shown in FIG. 4, the pixel electrode 20 of the second transparent conducting layer electrically connects to the source/drain layer 124 through a first contact via 201. In addition, the first transparent conducting layer 19 electrically connects to the touch signal line 14 through a second contact via 1911.

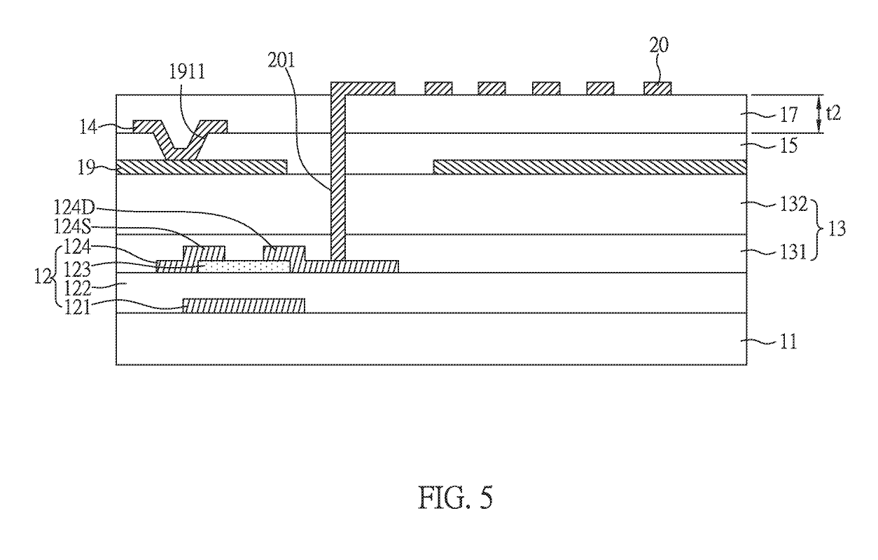

FIG. 5 is a cross-sectional view of a touch display device according to another comparative embodiment of the present disclosure. The structure of the touch display device and the process for preparing the same of the present comparative embodiment is similar to those of the touch display device shown in FIG. 4, except for the following differences.

As shown in FIGS. 4 and 5, in the touch display device shown in FIG. 5, the first insulating layer 13 has a double-layered structure, sequentially comprising an insulating layer 131 and a planer layer 132. This two-layered structure can also be applied to the first insulating layer 13 in the touch display device shown in FIG. 4.

In addition, in the touch display device shown in FIG. 5, after forming the first insulating layer 13, the first transparent conducting layer 19 is formed, and then the second insulating layer 15, the touch signal line layer comprising the touch signal line 14, the third insulating layer 17 and the second transparent conducting layer comprising the pixel electrode 20 are sequentially formed. However, in the touch display device shown in FIG. 4, after forming the first insulating layer 13, the touch signal line layer comprising the touch signal line 14 is formed, and then the second insulating layer 15, the first transparent conducting layer 19, the third insulating layer 17 and the second transparent conducting layer comprising the pixel electrode 20 are sequentially formed.

In the touch display device of shown in FIG. 5, in order to prevent the breakage of the touch signal line 14 due to the tiny particles adhered thereon, the thickness t2 of the third insulating layer 17 has to he increased to protect the touch signal line 14. However, the increased thickness t2 of the third insulating layer 17 causes the distance between the pixel electrode 20 and the first transparent conducting layer 19 increased; and this increased distance may cause the electric field between the pixel electrode and the common electrode decreased, resulting in the brightness and the flicker level of the display device worse. In order to improve the brightness of the display device, the voltage difference between the pixel electrode 20 and the first transparent conducting layer 19 has to be increased, resulting in the power consumption increased.

However, in the touch display device of the embodiment shown in FIG. 4, the touch signal line 14 is firstly formed, and then the common electrode (belonging to the first transparent conducting layer 19) and the pixel electrode 20 (belonging to the second transparent conducting layer) are formed. Hence, there are two insulating layers including the second insulating layer 15 and the third insulating layer 17 disposed on the touch signal line 14, so the total thickness of the insulating layer on the touch signal line 14 is the thickness t1 plus the thickness t2. Therefore, the thickness t2 of the third insulating layer 17 does not have to be increased, the purpose of protecting the touch signal line 14 and preventing the breakage of the touch signal line 14 can be achieved.

In addition, in the touch display device shown in FIG. 4, only the third insulating layer 17 is disposed between the pixel electrode 20 and the common electrode (belonging to the first transparent conducting layer 19). However, in the touch display device shown in FIG. 5, the second insulating layer 15 and the third insulating layer 17 are disposed between the pixel electrode 20 and the common electrode (belonging to the first transparent conducting layer 19), and the total thickness of the insulating layer between the pixel electrode 20 and the common electrode is the thickness t1 plus the thickness t2. Comparing the touch display devices shown in FIGS. 4 and 5, the distance between the pixel electrode 20 and the common electrode (belonging to the first transparent conducting layer 119) in the touch display device shown in FIG. 4 is smaller than that shown in FIG. 5. Hence, the storage capacitance between the pixel electrode 20 and the common electrode (belonging to the first transparent conducting layer 19) in the touch display device shown in FIG. 4 is higher than that shown in FIG. 5. Therefore, the voltage bias between the pixel electrode 20 and the common electrode (belonging to the first transparent conducting layer 19) does not have to be increased, the desired brightness of the touch display device shown in FIG. 4 still can be achieved.

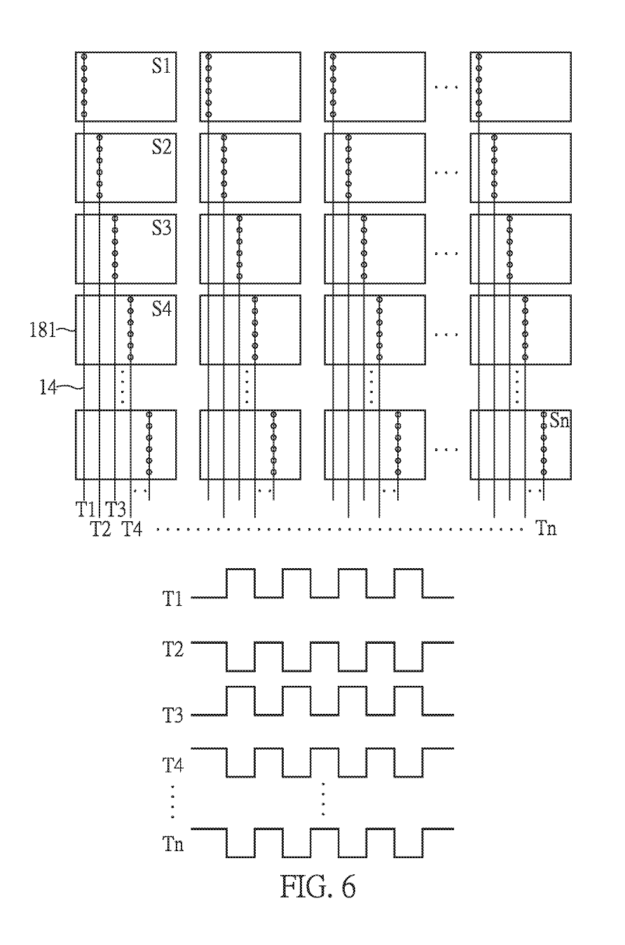

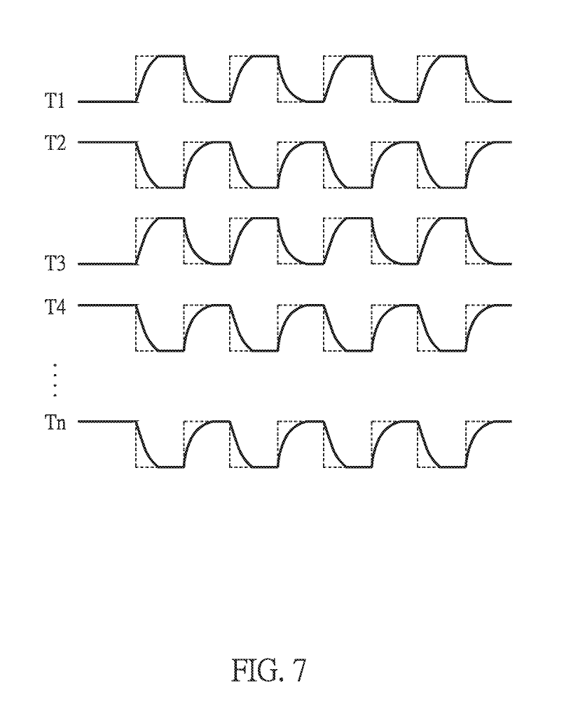

FIG. 6 is a timing diagram showing signals applied to the touch display device of the present disclosure. For simplified description, S1˜Sn are used to represent plural touch electrode patterns 181 arranged in the column direction, and T1˜Tn are used to represent the signals of the touch signal lines 14 electrically connected to the touch electrode patterns S1˜Sn; wherein S1, S2, S3, S4 . . . represent the touch electrode patterns 181 arranged in the column 1. As shown in FIG. 6, the signals applied to the touch electrode patterns 181 are, for example, square wave driving signals. For the signals (i.e., T1, T2, T3, T4 . . . ) of the touch signal lines 14 connected to the touch electrode patterns 181 (i.e., S1, S2, S3, S4 . . . ) of the same column, the signals (T1 and T2, T2 and T3, T3 and T4 . . . ) of the touch signal lines 14 connected to two adjacent touch electrode patterns (S1 and S2, S2 and S3, S3 and S4 . . . ) have inversed phases. That is, the phase of the signal T1 is inversed to the phase of the signal T2. In other words, the signals T1 and T2 are synchronously changed; and when the signal T1 is changed from high to low voltage levels, the signal T2 is changed from low to high voltage levels. Similarly, the signals T2 and T3 are synchronously changed; and when the signal T2 is changed from high to low voltage levels, the signal T3 is changed from low to high voltage levels. Moreover, the signals T3 and T4 are synchronously changed, too; and when the signal T3 is changed from high to low voltage levels, the signal T4 is changed from low to high voltage levels. However, the RC loading may cause the distortion of the inversed phase signals; and the actual signals are shown in FIG. 7. When the user touches a specific touch electrode pattern 181 (for example, S2 or S3), the capacitance/charge/signal of the corresponding region will be changed, and the changed capacitance/charge/signal influences the signal of the touch signal line 14 connected to the corresponding touch electrode pattern.

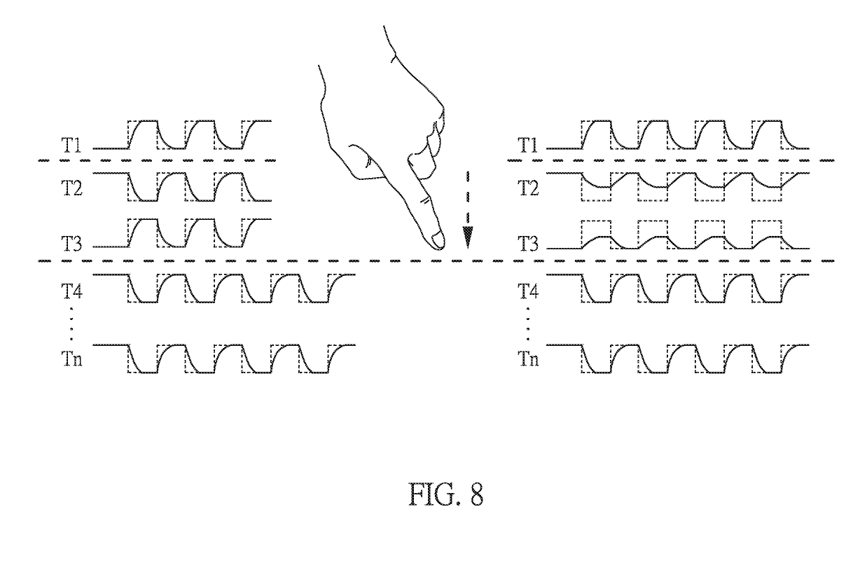

Since the signals of the touch signal lines 14 respectively connected to two adjacent touch electrode patterns 181 have inversed phase, after touching a plurality of touch electrode patterns 181, the capacitance coupling induced between the touch signal lines connected thereto and the touch electrode patterns 181 that are not connected to the aforementioned touch signal lines can he eliminated by counteracting, thereby reducing the change of the signals (T1 and T4) on the touch signal lines 14 connected to the touch electrode patterns 181 (S1 and S4) that are not touched, as shown in FIG. 8. Therefore, there are more significant signal differences between the touch signal lines 14 that the user does and does not touch; and the problem of the misjudgment of touching positions caused by the vertical crosstalk can be prevented.

The touch display devices provided by the aforementioned embodiments can be applied to any electronic device for displaying images and touch sensing, for example, monitors, mobile phones, notebooks, cameras, video cameras, music players, navigation systems, and televisions.

Although the present invention has been explained in relation to its preferred embodiment, it is to be understood that many other possible modifications and. variations can be made without departing from the spirit and scope of the invention as hereinafter claimed.

What is claimed is:

1. A touch display device, comprising:
a substrate;
a thin film transistor unit disposed on the substrate;
a first insulating layer disposed on the thin film transistor unit;
a touch signal line layer disposed on the first insulating layer;
a second insulating layer disposed on the touch signal line layer;
a first transparent conducting layer disposed on the second insulating layer;
a third insulating layer disposed on the first transparent conducting layer; and
a second transparent conducting layer disposed on the third insulating layer.

2. The touch display device of claim 1, wherein the thin film transistor unit comprises a source/drain layer, the first transparent conducting layer electrically connects to the source/drain layer through a first contact via, and the first transparent conducting layer is used as a pixel electrode.

3. The touch display device of claim 2, wherein the second transparent conducting layer comprises plural touch electrode patterns, and the touch electrode patterns electrically connect to the touch signal line layer through a second contact via.

4. The touch display device of claim 2, wherein the source/drain layer comprises a source electrode and a drain electrode, the touch signal line layer comprises a touch signal line, and the touch signal line corresponds to the source electrode or the drain electrode.

5. The touch display device of claim 4, wherein the touch signal line overlaps the source electrode or the drain electrode.

6. The touch display device of claim 1, wherein the thin film transistor unit comprises a source/drain layer, the second transparent conducting layer electrically connects to the source drain layer through a first contact via, and the second transparent conducting layer is used as a pixel electrode.

7. The touch display device of claim 6, wherein the first transparent conducting layer comprises plural touch electrode patterns, and the touch electrode patterns electrically connect to the touch signal line layer through a second contact.

8. The touch display device of claim 6, wherein the source/drain layer comprises a source electrode and a drain electrode, the touch signal line layer comprises a touch signal line, and the touch signal line corresponds to the source electrode or the drain electrode.

9. The touch display device of claim 8, wherein the touch signal line overlaps the source electrode or the drain electrode.

10. The touch display device of claim 1, wherein the second insulating layer has a thickness ranging from 10 nm to 1000 nm.

11. The touch display device of claim 1, wherein the third insulating layer has a thickness ranging from 10 nm to 1000 nm.
